(19) United States
(12) Patent Application Publication
(10) Pub. No.: US 2010/0187908 A1
(43) Pub. Date: Jul. 29, 2010

(54) Maintenance Bypass Device

(76) Inventors: Kouji Okano, Tokyo (JP); Katsuhiko Nakane, Tokyo (JP); Hiroyuki Shiina, Tokyo (JP); Hirokazu Kadoi, Tokyo (JP)

Correspondence Address: VON SIMSON & CHIN, 62 WILLIAM STREET, 6TH FLOOR, NEW YORK, NY, 10005, US

(21) Appl. No.: 12/665,609

(22) PCT Filed: May 20, 2008
(86) PCT No.: PCT/JP2008/059224

§ 371 Date: Dec. 18, 2009

(30) Foreign Application Priority Data
Jun. 21, 2007 (JP) 2007-163674

(51) Int. Cl. H02J 9/04

(52) U.S. Cl. 307/64

(57) ABSTRACT

There is provided a maintenance bypass device capable of achieving safety and efficiency in replacing work of a UPS. The maintenance bypass device (1) is equipped between a power supply (300) and a load device (400) and in parallel with an uninterruptible power supply unit (100), and supplies power from the power supply (300) to said load device (400) when the uninterruptible power supply unit (100) is being detached. In the maintenance bypass device (1), the connection portions (15, 16) of connecting wires (501, 502) connected to the uninterruptible power supply unit (100) are disposed on a front panel (2) disposed on the front side and are a connector type that enables the connection portions (15, 16) to be connected to and disconnected from the connection wires (501, 502) without using a tool.

### TECHNICAL FIELD

The present invention relates to a maintenance bypass device.

### BACKGROUND ART

It is unacceptable for some kinds of load devices driven by electric power, such as computers, semiconductor manufacturing lines, or medical devices, to be stopped even for a moment because of their functional and versatile importance. For such load devices, it may be provided with an uninterruptible power supply unit (abbreviated as UPS hereafter) between the commercial power supply and the load devices so that emergency power is supplied to the latter during a predetermined period even when the commercial power supply fails to supply the power.

A UPS comprises many parts some of which, such as a battery, a cooling fan and the like, have short lives compared to other parts. For maintaining normal operation of such a UPS, it is necessary to regularly or if it is necessary, check and replace any of parts with new one, or replace the UPS with new one.

During maintenance, an alternate UPS is used instead of the regularly used UPS and the latter UPS disconnected from the load device is checked during the alternate UPS is used. After the maintenance of the regularly used UPS is completed, the alternate UPS is replaced with the regularly used UPS.

However, as described above, some kinds of load devices such as computers can not accept any stoppage even for a moment. Namely, it is necessary to replace a part or whole of the UPS with new one without stoppage of power supply to the load device even when replacing it with new one. Hence, in order to avoid such stoppage, a maintenance bypass device is connected between the commercial power supply and the UPS so that it continues to supply power to the load device or devices during replacing the UPS with new one.

A maintenance bypass device, however, has only a function of connecting the commercial power supply with the load device during the UPS is disconnected, and has not a function for supplying power by means of a battery as a UPS has. Hence, in a case when the commercial power supply fails to supply power during a period when power from the commercial power supply is supplied to the load device through the maintenance bypass device, power supply to the load device is stopped. Namely, it is necessary to shorten time for supplying power to the load device through the maintenance bypass device as much as possible while the alternate UPS is replaced with the regularly used UPS during such shortened time. Accordingly it is desirable that the UPS is efficiently replaced as much as possible.

On the other hand, each of the patent documents 1 and 2 discloses a configuration in which, in general electronic devices, wire connections between the devices are performed on an operation panel placed in front of a device so as to efficiently connect electric devices and/or disconnect them. Further, the patent document 3 discloses a configuration in which a UPS is connected with a maintenance bypass device with a connector to contribute the efficiency of maintenance work for the UPS.

Patent Document 1: JP 2001-344042 A

Patent Document 2: JP 2001-284866 A

Patent Document 3: JP H8-111943 A

### DISCLOSURE OF INVENTION

### Subject to be Solved by the Invention

A UPS would be placed in a narrow space such as a narrow power supply room or a space free from the disturbance for a load device in a most case since a UPS is not routinely operated such as a load device. Namely, a UPS is mostly placed in a space in which it is hard to replace the UPS with new one. On the other hand, it is necessary to secure the safety of replacement work since a high voltage is applied to a UPS. Hence, it is required that time for replacing a UPS should be shortened as much as possible while securing the safety of replacement and smoothly replacing the UPS even in such a narrow space.

In order to overcome such difficulty, the invention is to provide a maintenance bypass device which is able to replace a UPS with improving safety and efficiency.

### Means to Solve the Subject

For solving the above mentioned subject, a maintenance bypass device which is equipped between a power supply and a load device and in parallel with an uninterruptible power supply unit, and supplies power from the power supply to the load device when the uninterruptible power supply unit is being detached, is configured that the connecting portions of connection wires connected to the uninterruptible power supply unit are disposed on a front panel disposed on the front side, and the connecting portions are formed in a connector type that enables the connection portions to be connected to and disconnected from the connection wires without using a tool.

According to the uninterruptible power supply configured as above, the work for connecting wires to disconnect from and connect to the uninterruptible power supply unit can be efficiently performed with safety and time for supplying a power to the load device through the maintenance bypass device can be shortened.

In addition to the above aspect of the invention, the maintenance bypass device may be mounted on a rack including a plurality of shelves and the thickness of the maintenance bypass device may be thinner than the width of an alignment direction of the shelf on which the maintenance bypass device is mounted.

According to the uninterruptible power supply configured as above, a space between the maintenance bypass device and the uninterruptible power supply unit can be formed when they are installed together on the same rack. Hence, this space enables an operator to easily complete the work for getting a connecting wire through the front of the maintenance bypass device, which is connected to the back side of the uninterruptible power supply unit.

In addition to the above aspect of the invention, the front panel of the maintenance bypass device may be placed at a position backward from the front side of the rack.

According to the uninterruptible power supply configured as above, the front panel is placed at the position backward from the front side of the rack to avoid an accident of disconnecting the connecting wire from the connecting portion due to an operator's careless contact with the connecting portion.

In addition to the above aspect of the invention, the maintenance bypass device may further comprise a protection panel in front of the front panel.

According to the uninterruptible power supply configured as above, the connecting portion can be protected from outer shock and the like, efficiently avoiding an accident of disconnecting the connecting wire from the connecting portion due to an operator's careless contact with the connecting portion.

In addition to the above aspect of the invention, the protection panel may be formed with a wider width compared to the front panel toward the direction of installing the uninterruptible power supply unit and covers over the front panel when viewed from the front.

According to the uninterruptible power supply configured as above, the connecting portion can be protected from outer shock and the like, further efficiently avoiding an accident of disconnecting the connecting wire from the connecting portion due to an operator's careless contact with the connecting portion.

### ADVANTAGE OF THE INVENTION

The present invention can provide a maintenance bypass device by which an operator efficiently replaces a UPS with safety.

### BRIEF DESCRIPTION OF DRAWINGS

FIG. 1 is a circuit block diagram showing a circuit configuration of a maintenance bypass device and a UPS connected to the maintenance bypass device.

FIG. 2 is a diagram showing the structure of an operation panel of the maintenance bypass device shown in FIG. 1.

FIGS. 3A to 3D are diagrams showing an outer configuration of the maintenance bypass device, in which FIG. 3A is a plane view of the maintenance bypass device, FIG. 3B is a front view of the maintenance bypass device, FIG. 3C is a left side view of the maintenance bypass device, and FIG. 3D is a right side view of the maintenance bypass device.

FIG. 4 is a perspective view showing a state that the maintenance bypass device and the UPS are mounted on a rack.

FIG. 5 is a diagram showing the mounting relationship between the maintenance bypass device and the UPS mounted on the rack in a view from the right side.

### REFERENCE NUMERALS

1: maintenance bypass device,
2: operation panel (front panel),
15, 16: receptacle (connection portion)
27: protection panel,
100: uninterruptible power supply unit,
200: rack,
203: housing space,
300: commercial power supply (power supply),
400: load device,
501A, 502A: connection wire

### BEST MODE FOR CARRYING OUT THE INVENTION

### Embodiment

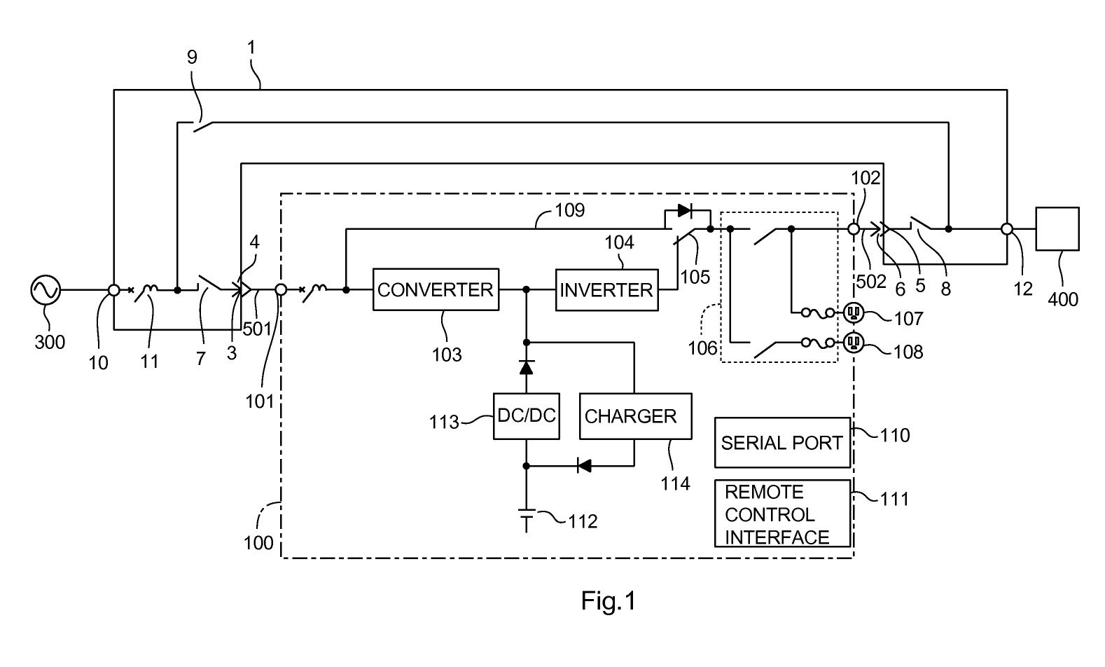

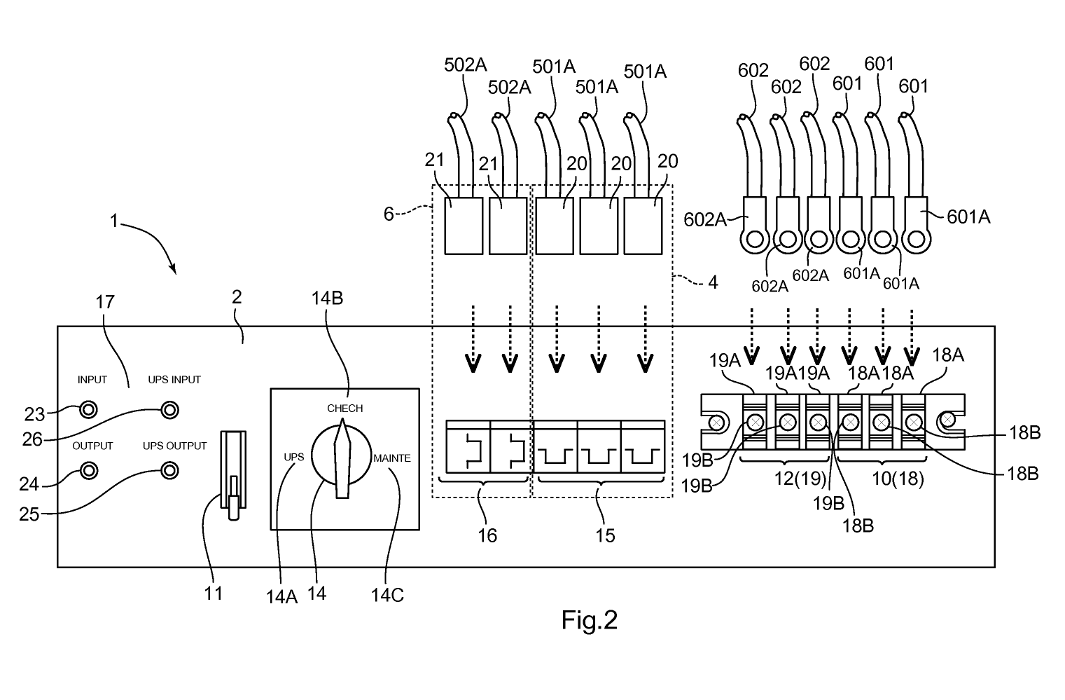

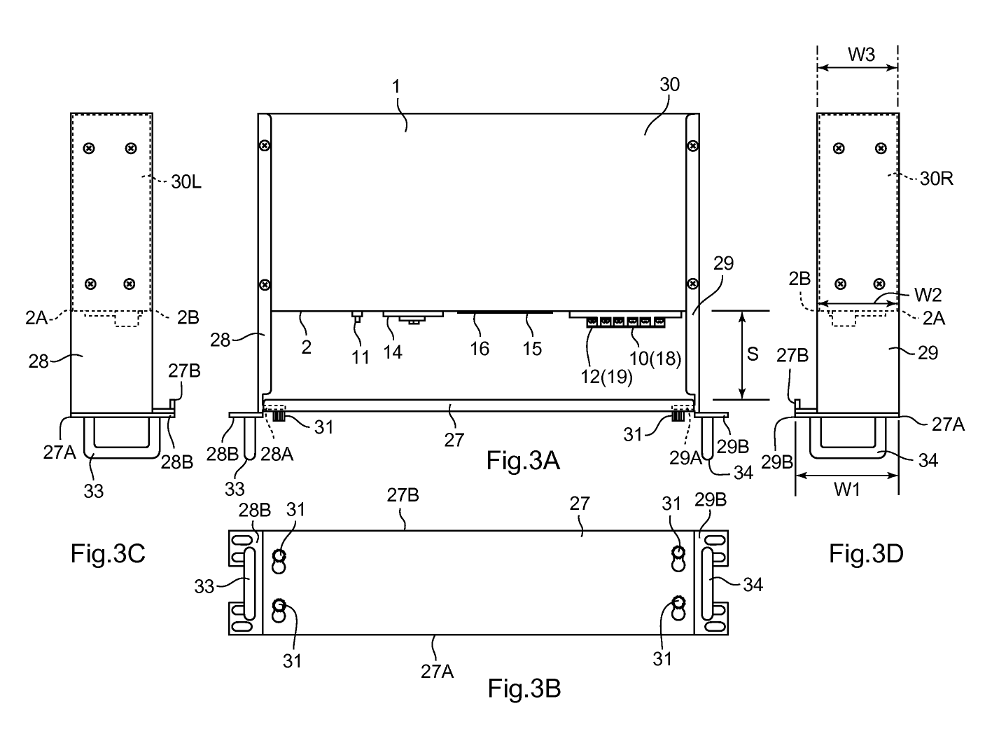

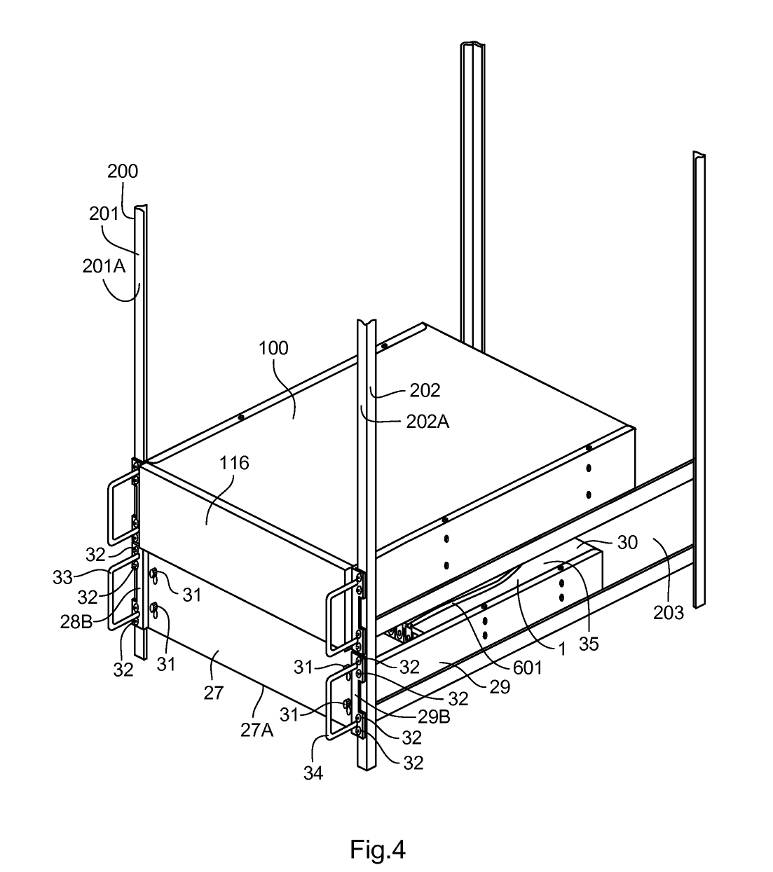

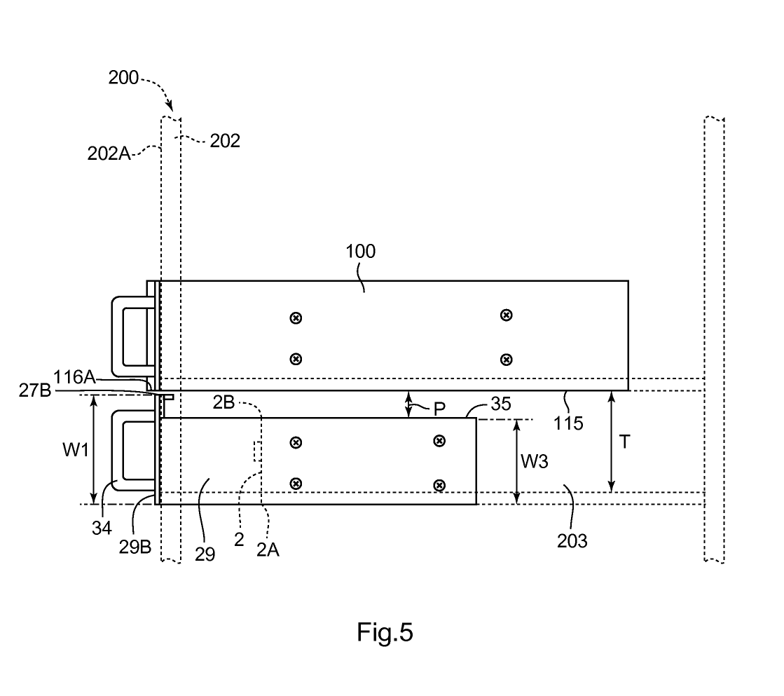

A configuration of a maintenance bypass device 1 in an embodiment of the invention will be explained hereafter by referring to FIG. 1 to FIG. 5. FIG. 1 is a circuit block diagram showing a circuit configuration of a maintenance bypass device 1 and a UPS 100 connected to the maintenance bypass device 1. FIG. 2 is a diagram showing the structure of an operation panel 2 as a front panel placed in front of the maintenance bypass device 1 shown in FIG. 1. FIGS. 3A to 3D are diagrams showing an outer configuration of the maintenance bypass device 1. FIG. 3A is a plane view of the maintenance bypass device 1. FIG. 3B is a front view of the maintenance bypass device 1. FIG. 3C and FIG. 3D are left and right side views of the maintenance bypass device 1 respectively. FIG. 4 is a perspective view showing a state that the maintenance bypass device 1 and the UPS 100 are mounted on a rack 200. FIG. 5 is a diagram showing the mounting relationship between the maintenance bypass device 1 and the UPS 100 mounted on the rack 200 in a view from the right side.

A circuit configuration of the maintenance bypass device 1 and the UPS 100 will be explained by referring to FIG. 1. As shown in FIG. 1, the maintenance bypass device 1 and the UPS 100 are placed, in electrical connections, between a commercial power supply 300 and a load device 400 such as a computer.

The maintenance bypass device 1 is placed electrically in parallel with the UPS 100 so that the commercial power supply 300 supplies alternative current (called as commercial current) to the load device 400 with being bypassed through the UPS 100. Namely, the maintenance bypass device 1 is connected to and in parallel with the UPS 100 through connecting wires 501 and 502.

One end of the connecting wire 501 is connected to an input terminal 101 of the UPS 100 and the other end is connected to a UPS side output terminal 3 of the maintenance bypass device 1. In such connections, the other end of the connecting wire 501 and the UPS side output terminal 3 are connected by a connector 4. The one end of the connecting wire 502 is connected to an output terminal 102 of the UPS 100 and the other end is connected to a UPS side input terminal 5 of the maintenance bypass device 1. The other end of the connecting wire 502 and the UPS side output terminal 5 are connected by a connector 6.

When the UPS 100 is used, that is, when the commercial power supply 300 supplies commercial current to the load device 400 through the UPS 100, switches 7 and 8 in the maintenance bypass device 1 are closed and a switch 9 is opened. Therefore, when the UPS 100 is used, the commercial current input to the input terminal 10 of the maintenance bypass device 1 passes through a breaker 11 to be output from the UPS side output terminal 3 to the UPS 100 side and is input to the input terminal 101 of the UPS 100.

The commercial current input to the input terminal 101 of the UPS 100 is converted to direct current by a converter 103. Then, the converted current is further converted into alternate current with a desired voltage and frequency by an inverter 104. The commercial current also passes through an alternative current switch 105 and a light emitting diode (LED) driver circuit 106 to be output to the output terminal 102, and then input to the UPS side input terminal 5 of the maintenance bypass device 1. Further, the commercial current is output to the output terminal 12 of the maintenance bypass device 1 and supplied to the load device 400 connected to the output terminal 12.

The alternative current switch 105 is to select one of passing the commercial current to the inverter 104 and passing the commercial current to a bypass line 109. The switch 105 switches a selected one mode into a predetermined mode to be selected when the UPS 100 is disconnected from the maintenance bypass device 1. The LED driver circuit 106 drives an LED 107 or 108 to emit light depending on a selected mode of the alternative current switch 105. More particularly, when the alternative current switch 105 is connected to the inverter 104, the LED driver circuit 106 makes the LED 107 on to emit light and the LED off. On the other hand, when the alternative current switch 105 is connected to the bypass line 109, the LED driver circuit 106 makes the LED 108 on to emit light and the LED 107 off. The UPS 100 herein is provided with a serial port 110 and a remote control interface 111 that are connected to a personal computer for monitoring and operating the UPS 100.

If the load device 400 is a computer, a semiconductor manufacturing device or a medical device, for example, it is necessary to avoid the stoppage of power supply (commercial current) to the load device 400 even for a short moment. However, it would happen that the commercial power supply 300 would be compelled to stop power supply such as lightning strike.

On the other hand, the UPS 100 is configured such that the direct current stored in the battery 112 in advance is output to the output terminal 102 as alternative current having a desired voltage and frequency through the DC/DC converter 113 and the inverter 104 when power supply from the commercial power supply 300 is stopped. Hence, even if the commercial power supply 300 fails to supply the power, the load device 400 can continue receiving power supplied from the battery 112 to operate. The battery 112 of the UPS 100 is always charged by the charger 114 when the commercial power supply 300 supplies power. Hence, the UPS 100 is configured so as to supply power to the load device 400 with being constantly fully charged when the commercial power supply 300 fails to supply the power.

The UPS 100 is provided with parts and devices having limited lives such as cooling fans not shown in the figures. Therefore, it is necessary to regularly, or if it becomes necessary, to perform maintenance such as replacing these parts with new ones or checking them and/or replace the UPS 100 itself with new one (having a similar configuration with the UPS 100) in order to maintain the normal operation of the UPS 100.

For performing maintenance, the UPS 100 as always used and an object to be checked is replaced with an alternate UPS (having a similar configuration with the UPS 100) in order to avoid an electric shock and the UPS, which is disconnected from the location between the commercial power supply 300 and the load device 400 and set to be under non-power supply, is maintained. After the maintenance of the normal UPS 100 is completed, the alternate UPS is replaced with the maintained normal UPS 100.

Thus, it would be caused that UPS 100 and the alternate UPS do not exist between the commercial power supply 300 and the load device 400 during a period until the time when the alternate UPS is disposed from the time when the UPS 100 is disconnected from the location between the commercial power supply 300 and the load device 400. Further, in a case when the alternate UPS is replaced with the UPS 100 after completion of maintenance, it would be also caused that the UPS 100 and the alternate UPS do not exist between the commercial power supply 300 and the load device 400 during a period until the time when the maintained UPS 100 is disposed from the time when the alternate UPS is disconnected from the location between the commercial power supply 300 and the load device 400. Further, in a case when the UPS 100 is replaced with a new one, it would be also caused that neither the UPS 100 nor the new UPS exists between the commercial power supply 300 and the load device 400 during a period until the time when the new UPS is disposed from the time when the UPS 100 is disconnected from the location between the commercial power supply 300 and the load device 400.

As described above, however, the stoppage of the operation of a load device such as a computer is prohibited even for a second. Namely, it is necessary to continue the work for replacing a part or a UPS with new one without stoppage of supplying the power to the load device 400 even when replacing the UPS 100 with the alternate UPS. Further, it is necessary to continue the work for replacing the UPS 100 with new one without stoppage of supplying the power to the load device 400.

As measures to satisfy such necessity, the maintenance bypass device 100 is disposed in parallel with the UPS 100 and between the load device 400 and the commercial power supply 300, continuing the supply of a commercial current power to the load device 400 even when the UPS 100 is disconnected. That is, the maintenance bypass device 1 is configured so as to supply a commercial current power to the load device 400 from the commercial power supply 300 even when the UPS 100 is disconnected from the load device 400.

The maintenance bypass device 100 comprises switches 7, 8 and 9 in which switches 7 and 8 are closed and the switch 9 is opened when the UPS 100 is used described above. On the other hand, when the UPS 100 is disconnected, switches 7 and 8 are opened and the switch 9 is closed. Hence, by closing the switch 9 and opening switches 7 and 8, the commercial current from the commercial power supply 300 is not to output to the UPS 100 but to output to the output terminal 12 of the maintenance bypass device 1 through the maintenance bypass device 100. That is, it can avoid the stoppage of supplying power to the load device 400 even when the UPS 100 is disconnected by means of supplying the commercial current to the load device 400 via the maintenance bypass device 1.

As described, during the period when the commercial current is supplied to the load device 400 with bypassing through the maintenance bypass device 1, the connection of the connecting wire 501 to the UPS side output terminal is detached and the connection of the connecting wire 502 to the UPS side input terminal is also detached. Then, the UPS 100 is disconnected from the location between the load device 400 and the commercial power supply 300 as well as connecting wires 501 and 502.

Next, in place of the UPS 100, the alternate UPS (having a similar configuration with the UPS 100) is connected to the maintenance bypass device 1. The input terminal 101 and the output terminal 102 of the alternate UPS are connected to one ends of connecting lines 501 and 502 respectively in advance. Such connections enables the alternate UPS to be connected to the maintenance bypass device 1 by connecting the other ends of connecting lines 501 and 502 to the UPS side output terminal 3 and the UPS side input terminal 5 respectively.

The switching operations of the switches 7, 8 and 9 and the disconnecting and connecting operations of the connectors 4 and 6 described above are also performed when the alternate UPS connected to the maintenance bypass device 1 is replaced with the maintained UPS 100, or when the UPS 100 connected to the maintenance bypass device 1 is replaced with new one.

The switches 7, 8 and 9 are switched in the following order for switching one state of using the UPS 100 in which the switches 7 and 8 are closed and the switch 9 is opened to another state using the maintenance bypass device 1 in which switches 7 and 8 are opened and the switch 9 is closed. First, the switch 9 is closed with keeping switches 7 and 8 closed. That is, all of the switches 7,8 and 9 are closed so that the load device 400 is connected to the commercial power supply 300 through both of the maintenance bypass device 1 and the UPS 100. Then, the switched 7 and 8 are opened with keeping closing the switch 9 so that the load device 400 is connected to the commercial power supply 300 through the maintenance bypass device 1 only.

By such switching of the switches 7, 8 and 9, it can be switched from one state in which the commercial current is supplied to the load device 400 through the UPS 100 to another state in which the commercial current is supplied through the maintenance bypass device 1 without stopping the supply of the commercial current.

The switches 7, 8 and 9 comprise a rotary switch 14 shown in FIG. 2 and others. The rotary switch 14 includes selective positions 14A, 14B and 14C for an operator to select one of them as shown in FIG. 2.

That is, the rotary switch 14 is configured such that the switches 7 and 8 are closed and the switch 9 is opened when the rotary switch 14 is turned into the selective position 14A. Further, the rotary switch 14 is also configured such that the switches 7, 8 and 9 are closed when the rotary switch 14 is turned into the selective position 14B and the switches 7 and 8 are opened and the switch 9 is closed when the rotary switch 14 is turned into the selective position 14C.

When switches 7, 8 and 9 are closed under the state in which the alternative current switch 105 is connected to the inverter 104, the low impedance of the inverter 104 causes the commercial current, which has flown into the maintenance bypass device 1, to flow into the UPS 100 to deteriorate the commercial current supply to the load device 400. In order to avoid such deterioration, the alternative current switch 105 is turned to the bypass line 109 side before the rotary switch 14 is turned into the selective position 14B from the selective position 14A. Then, the rotary switch 14 is turned into the selective positions 14B and 14C. This switching can avoid the deterioration of the commercial current supply to the load device 400.

The LED driver circuit 106 makes the LED 107 on to emit light when the alternative current switch 105 is connected to the inverter 104 side and makes the LED 108 on to emit light when the alternative current switch 105 is connected to the bypass wire 109 side. The emission of light enables the operator to get to know whether the alternative current switch 105 is connected to the bypass wire 109 side or the inverter 104 side by recognizing emitting states of the LEDs 107 and 108 and determine whether the switch 8 can be switched to close or not.

For disconnecting the alternate UPS from the maintenance bypass device 1, the rotary switch 14 is also turned into the selective positions 14B and 14C from the selective position 14A after the alternative current switch 105 is switched as described above. Further, for connecting the maintained UPS 100, the alternate UPS, or a new UPS to the maintenance bypass device 1 which is not yet connected any of them, the alternative current switch 105 included in the maintained UPS 100, the alternate UPS or the new UPS is turned to the bypass wire 109 side such that the commercial current, which flows into the maintenance bypass device 1, does not flow into the inverter 104.

After the UPS 100 is replaced with the alternate UPS, or after the alternate UPS is replaced with the UPS 100, or after the UPS 100 is replaced with new one, the switches 7 and 8 are closed and the switch 9 is opened. It causes that the commercial current from the commercial power supply 300 is supplied into the load device 400 through the UPS 100.

The outer configuration of the maintenance bypass device 1 will be explained by referring to FIG. 2 through FIG. 5.

As shown in FIG. 2, the operation panel 2 as a front panel of the maintenance bypass device 1 comprises the input terminal 10, the output terminal 12, a receptacle 15 of the connector 4, and a receptacle 16 of the connector 6, the rotary switch 14, a breaker 11 and a display 17 indicating operational states of the maintenance bypass device 1. The maintenance bypass device 1 in the embodiment is configured such that the side for an operator to operate the maintenance bypass device 1 or do the work is the front side and that the operation panel 2 is placed in front of the maintenance bypass device 1.

The input terminal 10 to be connected to the commercial power supply 300 (see FIG. 1) is constituted by a terminal base 18 and the output terminal 12 to be connected to the load device 400 is constituted by a terminal base 19. The terminal base 18 constituting the input terminal 10 comprises three terminal connecting portions 18A, 18A and 18A to which one ends of three conductive wires 601, 601 and 601 can be connected. The conductive wires 601, 601 and 601 are connected to the commercial power supply 300 at the other ends. Each of three conductive wires 601, 601 and 601 is provided for each phase of the commercial power supply 300 as a three phase electric power supply. Three terminal connecting portions 18A, 18A and 18A are configured such that solderless terminals 601A, 601A and 601A included in conductive wires 601,601 and 601 are fixed by screws 18B, 18B and 18B.

The terminal base 19 constituting the input terminal 12 comprises three terminal connecting portions 19A, 19A and 19A corresponding to three phases of the commercial power supply 300. The terminal connecting portions 19A, 19A and 19A are connected to ones of three conductive wires 602, 602 and 602 each of which is connected to the load device 400 at the other end (see FIG. 1). The terminal connecting portions 19A, 19A and 19A of conductive wires 602,602 and 602 are configured similar to the terminal connecting portions 18A, 18A and 18A so that solderless terminals 602A, 602A and 602A placed at the ends of these terminal connecting portions 19A, 19A and 19A are fixed by screws 19B, 19B and 19B.

According to the configuration of the terminal base 18 of the input terminal 10, it is necessary for an operator to screw or loosen three screws 18B at the time when conductive wires 601, 601 and 601 connected to the commercial power supply 300 are connected to or disconnected from the terminal base 18. However, it can achieve a strong contact state on each of the connections of the solderless terminals 601A, 601A and 601A to the terminal connecting portions 18A, 18A and 18A by means of the screws 18B securely screwed.

Similarly, according to the configuration of the terminal base 19 of the input terminal 12, it can achieve a strong contact state on each of the connections of the solderless terminals 602A, 602A and 602A to the terminal connecting portions 19A, 19A and 19A by means of three screws 19B securely screwed although it is necessary for an operator to screw or loosen the screws 19B at the time when conductive wires 602,602 and 602 connected to the load device 400 are connected to or disconnected from the terminal base 19.

The receptacle 15 constitutes the connector 4 in combination with a plug 20 provided at one end of the connecting wire 501. By putting the plug 20 into the receptacle 15, the UPS side output terminal 3 (see FIG. 1) is connected with the connecting wire 501. That is, the receptacle 15 constitutes a connecting portion for connecting the maintenance bypass device 1 and the connecting wire 501 so that the UPS side output terminal 3 and the connecting wire 501 are connected through the connector 4. The connector 4 is configured such that the plug 20 is grasped by an operator with his/her fingers and put into the receptacle 15 or pulled out from it so as to connect or disconnect the wires to or from the maintenance bypass device 1. That is, the connector 4 is configured such that the plug 20 is connected or disconnected to or from the receptacle 15 without using a specific tool. Although the connecting wire 501 is illustrated as a single wire in a block diagram shown in FIG. 1, it comprises, in actual, three conductive wires 501A, 501A and 501A each of which is provided with the plug 20 at the one end. The number of the receptacles 15 provided is three corresponding to the number of the plugs 20, 20 and 20 as shown in FIG. 2 so that the three plugs 20, 20 and 20 and three receptacles 15, 15 and 15 can be connected one another.

The other ends of conductive wires 501A, 501A and 501A are connected to the input terminal 101 of the UPS 100 as shown in FIG. 1. The input terminal 101 constitutes a terminal base (not shown in the figure) provided at the back side of the UPS 100 not shown in the figure, which has similar structure with the terminal bases 18 and 19.

The receptacle 16 constitutes the connector 6 in combination with a plug 21 provided at one end of the connecting wire 502. By putting the plug 21 into the receptacle 16, the UPS side output terminal 5 (see FIG. 1) is connected with the connecting wire 502. That is, the receptacle 16 connects constitutes a connecting portion for connecting the maintenance bypass device 1 and the connecting wire 502 so that the UPS side output terminal 5 and the connecting wire 502 are connected through the connector 6. The connector 6 is configured similarly to the connector 4 such that the plug 21 is connected or disconnected to or from the receptacle 16 without using a specific tool. Although the connecting wire 502 is illustrated as a single wire in a block diagram shown in FIG. 1, it comprises, in actual, two conductive wires 502A and 502A each of which is provided with the plug 21 at the end. The number of the receptacles 16 provided is two corresponding to the number of the plugs 21 and 21 as shown in FIG. 2 so that the two plugs 21 and 21 and two receptacles 16 and 16 can be connected one another.

The other ends of conductive wires 502A and 502A are connected to the input terminal 102 of the UPS 100 as shown in FIG. 1. The output terminal 102 constitutes a terminal base not shown in the figure (different from the terminal base to which the conductive wires 501A,501A and 501A are to be connected) provided at the back side of the UPS 100 not shown in the figure, which has similar structure with the terminal bases 18 and 19.

As described above, the conductive wires 601, 601 and 601 connected to the commercial power supply 300 is connected to the terminal base 18 and the conductive wires 602, 602 and 602 to be connected to the load device 400 is connected to the terminal base 19. Then, the conductive wires 501A, 501A and 501A are connected to the receptacle 15. Further, the conductive wires 502A, 502A and 502A to be connected to the output terminal 102 of the UPS 100 are connected to the receptacle 16. According to the predetermined wiring for the terminal bases 18 and 19 and the receptacles 15 and 16, the maintenance bypass device 1 can be disposed electrically in parallel with the UPS 100 between the commercial power supply 300 and the load device 400.

That is, by setting the rotary switch 14 to the selective position 14A, in which the switches 7 and 8 are closed and the switch 9 is opened, the commercial current input from the terminal base 18 can be output to the UPS side output terminal 3. The commercial current output to the UPS side output terminal 3 is input to the input terminal 101 provided at the backside of the UPS 100 through the conductive wires 501A, 501A and 501A connected to the connector 4 and output to the output terminal 102 provided at the backside of the UPS 100. The commercial current output to the output terminal 102 is input to the UPS side input terminal 5 of the maintenance bypass device 1 through the conductive wires 502A and 502A connected to the connector 6. The commercial current input to the input terminal 5 on the UPS side is output from the terminal base 19 and input to the load device 400 through conductive wires 602, 602 and 602.

The display 17 comprises four LEDs 23, 24, 25 and 26 which are used for an operator to monitor the normality of input or output of the commercial current to or from the maintenance bypass device 1. That is, the LED 23 indicates the input of the commercial current to the input terminal 10 (the terminal base 18) and the LED 24 indicates the output of the commercial current to the output terminal 12 (the terminal base 19.) The LED 25 indicates the output of the commercial current to the output terminal 3 (the receptacle 15) and the LED 26 indicates the input of the commercial current to the UPS side input terminal 5 (the receptacle 16). LEDs 23, 24, 25 and 26 emit light when the commercial current normally flows in the maintenance bypass device 1. But when the commercial current does not flow due to abnormality in the maintenance bypass device 1, any of LEDs 23, 24, 25 and 26 corresponding to a portion where the commercial current normally does not flow is not emit light. Accordingly, an operator can confirm the normal input or output of the commercial current to or from the maintenance bypass device 1 when he/she recognizes whether any of LEDs 23, 24, 25 and 26 emits light or not.

The maintenance bypass device 1 is provided a protection panel 27 in front of the operation panel 2 as shown in FIGS. 3A to 3D. The protection panel 27 is arranged with a space S apart from the operation panel 2 and supported by side surfaces 30L and 30R of the container 30 of the maintenance bypass device 1 through supporting plates 28 and 29.

Projection pieces 28A and 29A are provided on the supporting plates 28 and 29 respectively at the neighbor of the front end in which the protection panel 27 is attached. The projection pieces 28A and 29A protrude at right angles to the supporting plates 28 and 29 toward the inside. Further, projection pieces 28B and 29B are provided in the front direction from the projection pieces 28A and 29A to a certain degree with protruding at right angles to the supporting plates 28 and 29 toward the outside. The protection panel 27 is fixed to the projection pieces 28A and 29A with a screw 31. As the screw 31, a knurling screw, a wing screw or the like may be used for an operator to tighten or loosen the screw with his/her hand fingers. In this embodiment, a knurling screw is used.

The thickness (width) W1 toward up and down directions of the protection panel 27 is larger than the thickness (width) W2 toward up and down directions of the operation panel 2. The protection panel 27 is attached to the projection pieces 28A and 29A so that the lower end 27A of the protection panel 27 has the same height of the lower end 27A of the operation panel 2 and the upper end 27B of the protection panel 27 is projected upward from the upper end 27B of the operation panel 2. Accordingly, when an operator views the maintenance bypass device 1 from the front side, he/she recognizes that the protection panel 27 covers over the entire operation panel 2 and is located at a position which is higher than the upper end 27B of the operation panel 2.

The maintenance bypass device 1 is used after it is mounted in a rack 200 with the UPS 100 as shown in FIGS. 4 and 5. The maintenance bypass device 1 is mounted in the rack 200 such that the projection pieces 28A and 29A of the supporting plates 28 and 29 are contacted with front portion 201A and 202A of left and right pillars 201 and 202 on the front side of the rack 200, adjusting the position of the maintenance bypass device 1 toward back and front directions when it is mounted in the rack 200. The maintenance bypass device 1 is fixed to the rack 200 by fixing the projection pieces 28B and 29B to the left and right pillars 201 and 202 with a screw 32. Arms 33 and 34 are provided in the front of the projection pieces 28B and 29B. These arms 33 and 34 are used when an operator mounts the maintenance bypass device 1 in the rack 200 and detaches it from the rack 200.

The maintenance bypass device 1 is, as described above, covered with the protection panel 27 on the entire surface of the operation panel 2. Hence, the protection panel 27 can avoid an accident where the operator or another person gets a shock by electricity due to a careless contact with the terminal bases 18 and 19 and the like of operation panel 2 or he/she carelessly disconnects the connectors 4 and 6 by contacting them.

The maintenance bypass device 1 is provided with the space S between the operation panel 2 and the protection panel 27. Hence, when the maintenance bypass device 1 is mounted in the rack 200 with the positions of the projection pieces 28B and 29B being adjusted toward the pliers 201 and 202 of the rack 200, the operation panel 2 is placed at the position toward back of the front portions 201A, and 202A of the pillars 201 and 202 of the rack 200 with being apart by the distance S.

When an operator changes the UPS 100 or performs maintenance of it, the protection panel 27 is detached from the supporting plates 28A and 19A such that the operator can contact the operation panel 2 from the front view with his/her fingers. Even in such a case, as described above, the operation panel 2 is placed at the position toward back of the front portions 201A, and 202A of the pillars 201 and 202 of the rack 200 with being apart by the distance S. By placing the operation panel 2 at the position toward back of the front portion of the rack 200, it can avoid an accident that the operator or another person gets shock by electricity due to his/her careless contact with the operation panel 2 with his/her fingers.

The UPS 100 (an alternate UPS or a new UPS) is electrically connected or disconnected to or from the maintenance bypass device 1 by connecting or disconnecting the connectors 4 and 6 under the state of the protection panel 27 being disconnected. That is, the UPS 100 (an alternate UPS) can be electrically disconnected from the maintenance bypass device 1 only by pulling the receptacles 15 and 16 out of the plugs 20 and 21. The UPS 100 (an alternate UPS or a new UPS) is electrically connected to the maintenance bypass device 1 only by putting the plugs 20 and 21 into the receptacles 15 and 16.

That is, electrical connection or disconnection of the UPS 100 (an alternate UPS or a new UPS) to or from the maintenance bypass device 1 can be performed simply by connecting or disconnecting the connectors 4 and 6 so that a time for doing the work is shortened. Hence, such connection or disconnection shortens a period when the load device 400 directly receives a commercial current from the commercial power supply 300 through the maintenance bypass device 1 and reduces a risk of stoppage of power supply to the load device 400 due to the occurrence of power interruption on the commercial power supply 300. Further, the connectors 4 and 6 can be connected or disconnected without using a tool so that it can avoid an accident in which the tool short-circuits the terminals. Each of the connectors 4 and 6 may be constituted by, for example, a combination of a plug with a jack, a socket or the like as a receptacle.

As shown in FIG. 5, the thickness W3 toward up and down directions of the casing 30 of the maintenance bypass device 1 is thinner than the width T toward the up and down directions of the housing space 203 in which the maintenance bypass device 1 is mounted in the rack 200. That is, these up and down directions are stacking directions in which the maintenance bypass device 1 and the UPS 100 are mounted in the rack 200. In this embodiment, the thickness (width) W2 of the control panel 2 is almost equal to the thickness W3 of the maintenance bypass device 1. Thus, by setting the thickness W3 of the maintenance bypass device 1 to be thinner than the width T toward the up and down directions of the housing space 203 of the tack 200, a space P is formed between an upper surface 35 of the maintenance bypass device 1 and a lower surface 115 of the UPS 100. Further, the thickness W3 of the maintenance bypass device 1 is configured such that the space P is wider than the thicknesses of the conductive wires 501A, 501A, and 501A and the conductive wires 502A and 502A. Therefore, the conductive wires 501A, 501A and 501A and the conductive wires 502A, and 502A can be taken out from the back side of the UPS 100 to the front side of the operation panel 2 located in the front of the maintenance bypass device 1 through the space P. Further, the receptacles 15 and 16 of the connectors 4 and 6 for connecting between the conductive wires 501A, 501A, and 501A and the conductive wires 502A, and 502A and the maintenance bypass device 1 can be placed on the operation panel 2.

That is, the receptacles 15 and 16 of the connectors 4 and 6 in the operation panel 2 enables an operator to easily connect or disconnect the conductive wires 501A, 501A, and 501A and the conductive wires 502A and 502A to or from the maintenance bypass device 1 when the protection panel 27 is detached.

The UPS 100 has a heavy weight due to including the battery 112. Hence, in many cases, the UPS 100 is mounted on the lower shelf of the rack 200 in order to avoid the falling down of the UPS 100 due to an earthquake or the like. On the other hand, it is preferable that the maintenance bypass device 1 is placed near the UPS 100 since it is used for maintaining the UPS 100. Hence, in many cases, the maintenance bypass device 1 is mounted on the lower shelf of the rack 200. That is, the maintenance bypass device 1 is placed at a position which is lower than the eye level of an operator under the situation that it is mounted on the rack 200.

Therefore, the protection panel 27 covers over a position which is higher than the upper edge 2B of the protection panel 27, effectively protecting the operator or another person from carelessly inserting his/her fingers or the like into the operation panel from the upper portion of the protection panel 27.

The thickness (width) W1 toward upper and lower directions of the protection panel 27 is configured so as to satisfy the following conditions. The maintenance bypass device 1 mounted on the shelf of the rack 200 is looked attractive from the front view and the space between the upper portion of the space 203 in the shelf on which the maintenance bypass device 1 and the upper edge 27B of the protection panel 27 is made to be narrowed. That is, as shown in FIGS. 4 and 5, when the UPS 100 is mounted on the upper side of the shelf where the maintenance bypass device 1 is mounted, the thickness (the width) W1 toward upper and lower directions of the protection panel 27 is adjusted such that the space between the lower edge 116A of the operation panel 116 of the UPS 100 and the upper edge 27B of the protection panel 27 of the maintenance bypass device 1 is made to be narrowed.

Accordingly, the protection panel 27 is configured such that the space between the lower edge 116A of the operation panel 116 of the UPS 100 and the upper edge 27B of the protection panel 27 of the maintenance bypass device 1 is made to be narrowed. According such configuration, the operator or another person can be effectively prevented from carelessly inserting his/her fingers or the like into the space between the lower edge 116A of the operation panel 116 of the UPS 100 and the upper edge 27B of the protection panel 27 of the maintenance bypass device 1 and carelessly touching the operation panel 2.

1. A maintenance bypass device which is equipped between a power supply and a load device and in parallel with an uninterruptible power supply unit, and supplies power from said power supply to said load device when said uninterruptible power supply unit is being detached, wherein;
connecting portions of connecting wires connected to said uninterruptible power supply unit are disposed on a front panel disposed on the front side, and
said connecting portions are formed in a connector type that enables said connection portions to be connected to and disconnected from said connection wires without using a tool.

2. The maintenance bypass device according to claim 1, which is a rack-mountable device to be mounted on a rack having a plurality of shelves, and the thickness of which is thinner than the width of the housing space in the direction of the arrangement of the shelves in which said maintenance bypass device is mounted.

3. The maintenance bypass device according to claim 2, wherein a front panel is placed at the position backward from the front surface of the rack.

4. The maintenance bypass de % ice according to claim 2, wherein a protection panel is placed in a position forward from the front panel.

5. The maintenance bypass device according to claim 4, wherein said protection panel is formed with a wider width compared to the front panel toward the direction of disposing said uninterruptible power supply unit and covers over the front panel viewed from the front.

6. The maintenance bypass device according to claim 3, wherein a protection panel is placed in a position forward from the front panel.
